(19) United States
(12) Patent Application Publication
(10) Pub. No.: US 2025/0014548 A1
(43) Pub. Date: Jan. 9, 2025

(54) SOUND SOURCE SYSTEM, METHOD, AND NON-TRANSITORY RECORDING MEDIUM

(71) Applicant: CASIO COMPUTER CO., LTD., Tokyo (JP)

(72) Inventor: Goro SAKATA, Tokyo (JP)

(21) Appl. No.: 18/892,102

(22) Filed: Sep. 20, 2024

Related U.S. Application Data
(63) Continuation of application No. PCT/JP2023/006012, filed on Feb. 20, 2023.

(30) Foreign Application Priority Data
Mar. 23, 2022 (JP) 2022-046539

(51) Int. Cl. G10H 1/00

(52) U.S. Cl. CPC G10H 1/0033; G10H 2210/375

(57) ABSTRACT

A sound source system has a configuration including: a plurality of sound source cores that process musical sound data; a phase control circuit that aligns phases of clocks defining an input/output timing of the musical sound data with respect to a sound source core among the plurality of sound source cores; and a connection control circuit that controls connection among the plurality of sound source cores such that musical sound data in which phases of the clocks are aligned is transferred among the plurality of sound source cores.

### CROSS REFERENCE TO RELATED APPLICATIONS

This application is a continuation of International Patent Application No. PCT/JP2023/006012 filed on Feb. 20, 2023, and claims priority to Japanese Patent Application No. 2022-046539 filed on Mar. 23, 2022, the entire content of both of which is incorporated herein by reference.

### TECHNICAL FIELD

The disclosure of the present specification relates to a sound source system, a method, and a non-transitory recording medium.

### BACKGROUND ART

A sound source system including a plurality of sound source cores is known. For example, Patent Literature 1 describes a specific configuration of this type of sound source system.

The sound source system described in Patent Literature 1 mixes digital musical sound data output from a plurality of sound source cores by a mixer, applies effect processing to the mixed digital musical sound data, adds the digital musical sound data subjected to the effect processing, converts the digital musical sound data into an analog signal, and outputs the analog signal.

### CITATION LIST

### Patent Literature

Patent Literature 1: JP H7-129161 A

### SUMMARY OF THE INVENTION

The present disclosure has been made in view of the above circumstances, and an object thereof is to provide a sound source system, a method, and a non-transitory recording medium capable of sharing DSP resources among a plurality of sound source cores without increasing a circuit scale.

A sound source system according to an embodiment of the present disclosure includes: a plurality of sound source cores that process musical sound data; a phase control circuit that aligns phases of clocks defining an input/output timing of the musical sound data with respect to a sound source core among the plurality of sound source cores; and a connection control circuit that controls connection among the plurality of sound source cores such that musical sound data in which phases of the clocks are aligned is transferred among the plurality of sound source cores.

### BRIEF DESCRIPTION OF THE DRAWINGS

FIG. 1 is a block diagram illustrating a configuration of a sound source system according to an embodiment of the present disclosure.

FIG. 2 is a block diagram illustrating a configuration of a sound source core included in a sound source system according to an embodiment of the present disclosure.

FIG. 3 is a block diagram illustrating a configuration of a reset pulse input/output circuit provided in a sound source core according to an embodiment of the present disclosure.

FIG. 4 is a diagram illustrating a timing chart of inter-IC sound interface (I²S) data.

FIG. 5 is a block diagram illustrating a configuration of a switch matrix circuit included in a sound source system according to an embodiment of the present disclosure.

FIG. 6 is a diagram illustrating an example of effect processing by a DSP provided in a sound source system according to an embodiment of the present disclosure.

FIG. 7A is a diagram illustrating latency in a case where digital musical sound data is transferred in an I²S format according to an embodiment of the present disclosure.

FIG. 7B is a diagram illustrating latency in a case where digital musical sound data is transferred via a shared memory in an embodiment of the present disclosure.

FIG. 8 is a diagram illustrating an example of effect processing by a DSP provided in a sound source system according to a first modification of the present disclosure.

FIG. 9A is a block diagram illustrating a configuration for performing synchronization control of an operation counter according to a second modification of the present disclosure.

FIG. 9B is a block diagram illustrating a configuration for performing synchronization control of the operation counter according to the second modification of the present disclosure.

FIG. 10 is a block diagram illustrating a configuration of a sound source system according to a third modification of the present disclosure.

### DESCRIPTION OF EMBODIMENTS

A sound source system, a method, and a program according to an embodiment of the present disclosure will be described in detail with reference to the drawings.

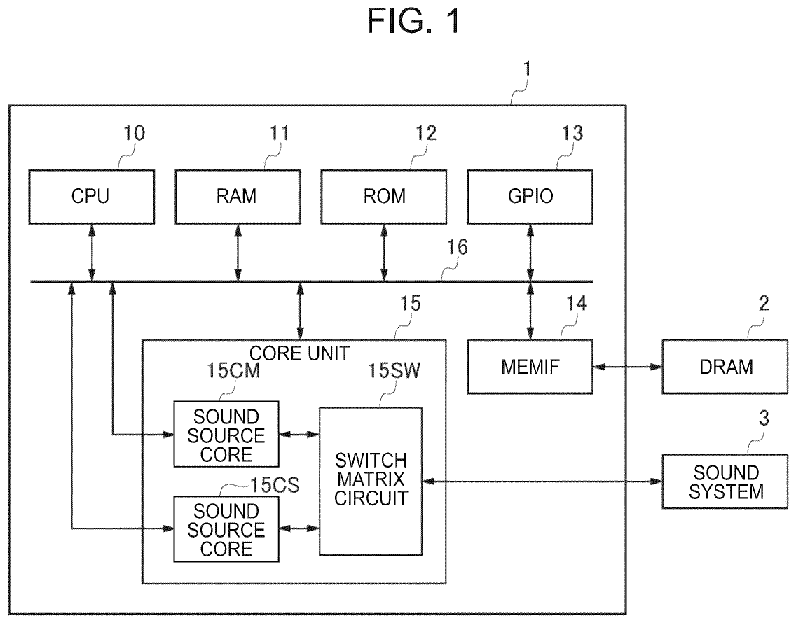

FIG. 1 is a block diagram illustrating a configuration of a sound source system 1 according to an embodiment of the present disclosure. The sound source system 1 is configured as, for example, a large scale integration (LSI), and is built in an electronic musical instrument such as an electronic keyboard. The sound source system 1 is not limited to an electronic musical instrument, and may be built in a smartphone, a personal computer (PC), a tablet terminal, a portable game machine, a feature phone, a personal digital assistant (PDA), or the like.

As illustrated in FIG. 1, the sound source system 1 includes a central processing unit (CPU) 10, a random access memory (RAM) 11, and a read only memory (ROM) 12, a general purpose input/output (GPIO) 13, a memory interface (MEMIF) 14, and a core unit 15. Each unit of the sound source system 1 is connected via a bus 16. Each unit of the sound source system 1 operates with a basic operation clock supplied from a clock generator (not illustrated).

The CPU 10 reads a program and data stored in the ROM 12 and uses the RAM 11 as a work area to integrally control the sound source system 1. That is, when the CPU 10 executes the program, the sound source system 1 operates.

The CPU 10 is, for example, a single processor or a multiprocessor, and includes at least one processor. In the case of a configuration including a plurality of processors, the CPU 10 may be packaged as a single device, or may be configured by a plurality of devices physically separated in the sound source system 1.

The RAM 11 is, for example, a static random access memory (SRAM), and operates at a higher speed than a dynamic random access memory (DRAM) 2 to be described later. Therefore, the RAM 11 temporarily holds data and programs in processing requiring high-speed operation. The RAM 11 holds programs and data read from the ROM 12 and other data necessary for communication.

Furthermore, as will be described later, the RAM 11 operates as a shared memory shared among a plurality of sound source cores.

The ROM 12 is a nonvolatile semiconductor memory such as a flash memory, an erasable programmable ROM (EPROM), or an electrically erasable programmable ROM (EEPROM). The ROM 12 stores programs and data used by the CPU 10 to perform various processing.

In addition, the ROM 12 stores, for example, waveform data for each key number for each timbre (Guitars, bass, piano, and the like).

The GPIO 13 is a general-purpose port mounted on the sound source system 1 which is an LSI. For example, a musical instrument digital interface (MIDI) device (not illustrated) is connected to the GPIO 13. In this case, MIDI data (an example of standard MIDI file (SMF) data) conforming to the MIDI standard is input from the MIDI device via the GPIO 13.

The MEMIF 14 is, for example, an interface connected to the external DRAM 2. The DRAM 2 is slower in reading and writing data than the SRAM, but generally has a large capacity. Therefore, the DRAM 2 stores data that does not require high-speed processing or data with a large capacity, for example, SMF data. In this case, the SMF data is input from the DRAM 2 via the MEMIF 14.

The music data input via the GPIO 13 or the MEMIF 14 is not limited to the SMF data, and may be music data conforming to another standard.

The core unit 15 includes two sound source cores 15CM and 15CS and a switch matrix circuit 15SW. In the present embodiment, the sound source core 15CM and the sound source core 15CS have the same circuit structure. Note that, in a case where the sound source core 15CM and the sound source core 15CS are collectively described, each is referred to as a “sound source core 15C”.

The core unit 15 outputs the digital musical sound data generated by each sound source core 15C to a sound system 3 in the I²S format via the switch matrix circuit 15SW. Note that the number of sound source cores 15C included in the core unit 15 is not limited to two, and may be three or more.

The sound system 3 includes a D/A converter, an amplifier, a speaker, and the like. The sound system 3 converts digital musical sound data input in the I²S format into an analog signal, amplifies the converted analog signal with the amplifier, and outputs the amplified analog signal from the speaker. Therefore, for example, a musical sound corresponding to the MIDI data is reproduced.

Furthermore, the sound system 3 may include input means such as an A/D converter and a microphone. For example, a singing voice input from the microphone may be converted into digital data by the A/D converter, then the digital data may be input to the core unit 15, and an effect may be added to the singing voice.

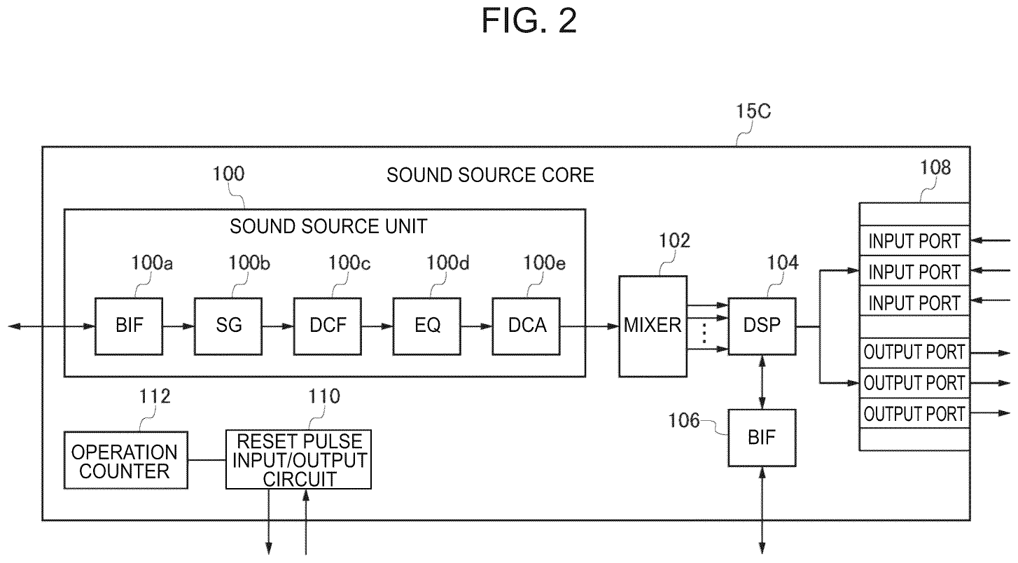

FIG. 2 is a block diagram illustrating a configuration of the sound source core 15C that processes digital musical sound data. In the present embodiment, two sound source cores 15C having the same structure are included, and it is not necessary to prepare a plurality of types of sound source cores 15C having different structures. Therefore, the sound source system 1 can be reduced in cost, and the sound source core 15C can be easily managed.

The sound source core 15C includes an n-channel (for example, 128 channels) sound source unit 100, a mixer 102, a DSP 104, a BIF 106, an I²S interface 108, a reset pulse input/output circuit 110, and an operation counter 112.

The sound source unit 100 includes a bus interface (BIF) 100a, a sound generator (SG) 100b, a digital controlled filter (DCF) 100c, an equalizer (EQ) 100d, and a digital controlled amplifier (DCA) 100e.

The BIF 100a is an interface connected to each unit of the sound source system 1 via the bus 16. For example, the CPU 10 instructs the sound source core 15C to read the corresponding waveform data from among the plurality of waveform data stored in the ROM 12 according to the MIDI data input to the GPIO 13. This instruction signal is input to the SG 100b via the BIF 100a.

The SG 100b reads waveform data from the ROM 12 in accordance with an instruction signal from the CPU 10, and generates digital musical sound data on the basis of the read waveform data. Since the sound source core 15C includes the 128-channel sound source unit 100, it is possible to simultaneously perform sound production processing of up to 128 musical sounds.

The digital musical sound data generated by the SG 100b is output to the mixer 102 through the digital filter processing by the DCF 100c, the equalizer processing by the EQ 100d, and the amplification processing by the DCA 100e.

The mixer 102 mixes digital musical sound data of up to 128 musical sounds input from the sound source unit 100 and outputs the digital musical sound data to the DSP 104.

The DSP 104 performs effect processing on the digital musical sound data input from the mixer 102 and outputs the digital musical sound data to the I²S interface 108. Furthermore, the DSP 104 is connected to each unit of the sound source system 1 via the BIF 106.

The I²S interface 108 is an interface for transferring the digital musical sound data in the I²S format between the DSPs 104 of the sound source cores 15C or between the DSP 104 and the switch matrix circuit 15SW. For convenience, the digital musical sound data transferred in the I²S format is referred to as “I²S data”.

The I²S data includes a BCK signal, an LRCK signal, and a DATA signal. The BCK signal is a clock for latching the DATA signal which is serial data at a rising edge, and may be referred to as a bit clock. The LRCK signal discriminates between the L channel and the R channel of the digital musical sound data and indicates the position of the most significant bit of the DATA signal, and is sometimes referred to as a word clock. The DATA signal is a signal of a bit string of musical sound data, and includes a most significant bit MSB and a least significant bit LSB.

The I²S interface 108 includes three input ports and three output ports. The I²S interface 108 inputs and outputs the I²S data via each port. Note that each of the number of input ports and the number of output ports included in the I²S interface 108 is not limited to three. Each of the number of input ports and the number of output ports may be two or less, or may be four or more.

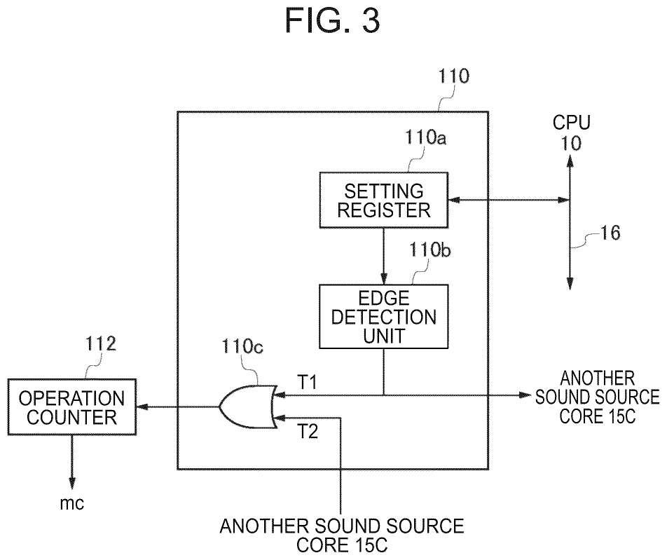

FIG. 3 is a block diagram mainly illustrating a configuration of a reset pulse input/output circuit (control signal output unit) 110. The CPU 10 outputs an instruction signal instructing issuance of a reset pulse to the reset pulse input/output circuit 110 at a predetermined timing (for example, when the sound source system 1 is activated, or when the operation of the sound source core 15CS in the stopped state is restarted as described later). The reset pulse input/output circuit 110 generates a reset pulse (reset signal), which is an example of a trigger signal, in accordance with an instruction signal from the CPU 10, and outputs the generated reset pulse to the operation counter (value generation unit) 112.

As illustrated in FIG. 3, the reset pulse input/output circuit 110 includes a setting register (setting unit) 110a, an edge detection unit 110b, and an OR circuit (logical OR circuit or control signal output circuit) 110c. Here, Operation Examples 1 and 2 of the reset pulse input/output circuit 110 will be described.

In Operation Example 1, when the reset pulse input/output circuit 110 receives an instruction signal of reset pulse issuance from the CPU 10, the setting register 110a modulates the setting value from “0” to “1”. The edge detection unit 110b detects a rising edge of a signal when the setting value in the setting register 110a is modulated from “0” to “1” to generate a reset pulse according to the edge, and outputs the generated reset pulse to the OR circuit 110c.

In the OR circuit 110c, one input terminal T1 is connected to the edge detection unit 110b, and the other input terminal T2 is connected to the other sound source core 15C. However, in Operation Example 1, the input to the input terminal T2 is fixed to “0”. Therefore, the OR circuit 110c outputs an output signal corresponding to the reset pulse from the edge detection unit 110b to the operation counter 112 only when the reset pulse from the edge detection unit 110b is input to the input terminal T1.

The operation counter 112 is, for example, a timing generator, and always generates a value mc serving as an operation reference of the sound source core 15C during the operation of the sound source system 1. The value mc is used to generate, for example, a BCK signal and an LRCK signal which are clocks. For example, the logic circuit mounted on the I²S interface 108 generates the BCK signal and the LRCK signal based on the value mc generated by the operation counter 112.

When a reset pulse is input from the reset pulse input/output circuit 110 to the operation counter 112, the value mc generated by the operation counter 112 is reset to “0”.

That is, when the instruction signal of the reset pulse issuance by the CPU 10 is input to each sound source core 15C, the value mc is simultaneously reset to “0” in each sound source core 15C. After the value mc is reset, the counting-up of the value mc is simultaneously restarted in each sound source core 15C.

Therefore, the values mc of the operation counters 112 of the sound source cores 15C are synchronized (substantially matched). Therefore, the phases of the BCK signal and the LRCK signal generated based on the value mc are aligned between the two sound source cores 15C.

There is an individual difference in the operation counter 112 of each sound source core 15C. Therefore, strictly speaking, the BCK signal and the LRCK signal are not in synchronization but in a state in which the phases are aligned. However, since the individual difference of the operation counter 112 is small, it is substantially acceptable to describe that “the BCK signal and the LRCK signal are synchronized between the two sound source cores 15C”. Here, the fact that the phases are aligned means that, for example, even in a case where the clock waveform is rounded or deformed due to a factor such as a capacity between wirings, or in a case where the clock is slightly shifted between the sound source cores 15C due to a delay, it is sufficient that the high section of the clock waveform of one sound source core 15C and the high section of the clock waveform of the other sound source core 15C substantially coincide with each other, and the low section of the clock waveform of one sound source core 15C and the low section of the clock waveform of the other sound source core 15C substantially coincide with each other.

Furthermore, since the plurality of operation counters 112 operate in synchronization, fan-out of one operation counter 112 is reduced.

In Operation Example 1, the CPU 10 instructs all the sound source cores 15C to issue reset pulses. On the other hand, in Operation Example 2, the CPU 10 instructs only the sound source core 15CM set as a master to issue the reset pulse.

In Operation Example 2, the reset pulse input/output circuit 110 of the sound source core 15CM outputs the reset pulse not only to the operation counter 112 but also to the other sound source core 15CS set as a slave.

In the OR circuit 110c of the sound source core 15CM, the input to the input terminal T2 is fixed to “0”,similarly to Operation Example 1. Therefore, as in Operation Example 1, the OR circuit 110c of the sound source core 15CM outputs the reset pulse from the edge detection unit 110b to the operation counter 112 only when the reset pulse is input to the input terminal T1.

On the other hand, the input to the input terminal T2 is not fixed in the OR circuit 110c of the sound source core 15CS. Furthermore, since the reset pulse is not generated in the sound source core 15CS, there is no input to the input terminal T1. Therefore, only when the reset pulse from the sound source core 15CM is input to the input terminal T2, the OR circuit 110c of the sound source core 15CS outputs the reset pulse to the operation counter 112.

In Operation Example 2, the value mc is simultaneously reset to “0” in each sound source core 15C only by instructing the sound source core 15CM to issue the reset pulse, and the phases of the BCK signal and the LRCK signal are aligned between the two sound source cores 15C.

Since the sound source cores 15C having the same structure can be used in either case of Operation Examples 1 and 2, it is not necessary to separately prepare and incorporate a plurality of types of sound source cores 15C.

As described above, the CPU 10 operates as a phase control unit that supplies a reset pulse, which is an example of a trigger signal, to each of the plurality of sound source cores 15C by executing the program stored in the ROM 12. When the reset pulse is supplied to each of the plurality of sound source cores 15C, the value mc of the operation counter 112 is synchronized among the plurality of sound source cores 15C, and each of the plurality of sound source cores 15C generates the BCK signal and the LRCK signal which are examples of the clock based on the value mc of the operation counter 112 in the synchronized state. That is, the CPU 10 operating as a phase control unit aligns the phases of the clocks (the BCK signal and the LRCK signal) that define the input/output timing of the digital musical sound data with respect to the sound source core 15C among the plurality of sound source cores 15C.

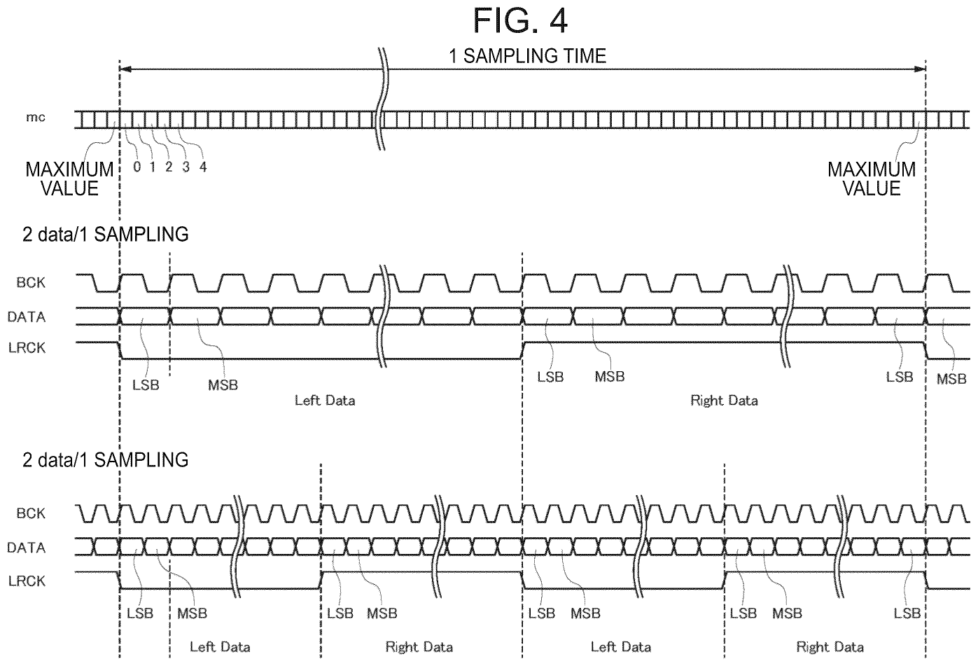

FIG. 4 is a diagram illustrating a timing chart of the I²S data. In FIG. 4, a transfer example in which data of two channels is transferred by one sampling and a faster transfer example in which data of four channels is transferred by one sampling are also illustrated. In the former transfer example, the L-channel data and the R-channel data are sequentially transferred during one sampling. In the latter transfer example, the L-channel data, the R-channel data, the L-channel data, and the R-channel data are sequentially transferred during one sampling.

In any transfer example, the BCK signal and the LRCK signal are generated on the basis of the value mc illustrated at the top in FIG. 4.

Note that a configuration for transferring data of more channels during one sampling, such as 8, 16, and 32 channels, is also within the scope of the present disclosure.

Furthermore, the transfer format of the digital musical sound data is not limited to the I²S format, and may be another format such as left justified or right justified.

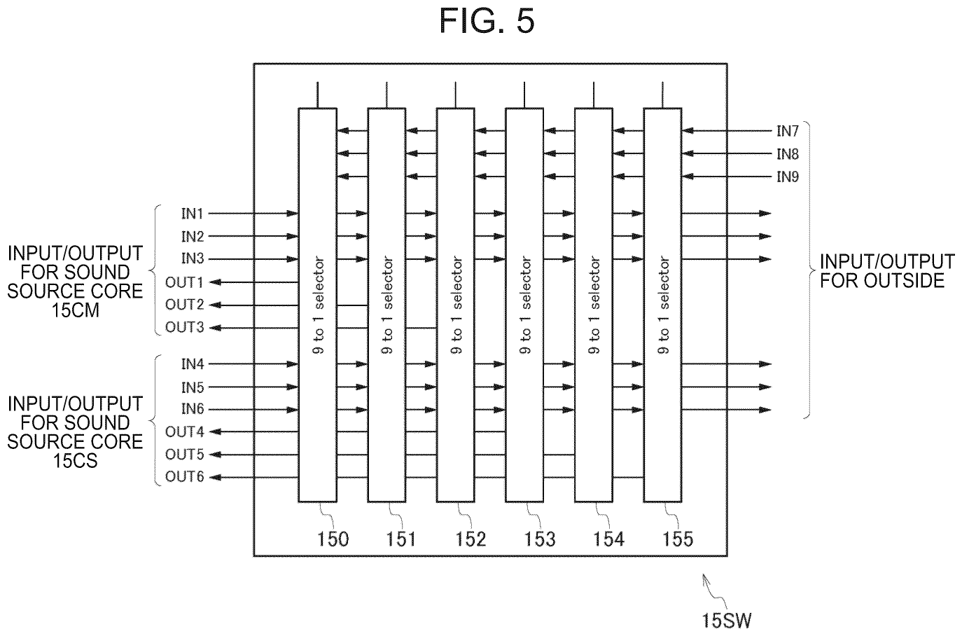

FIG. 5 is a block diagram illustrating a configuration of the switch matrix circuit 15SW connectable to each of the plurality of sound source cores 15C. As illustrated in FIG. 5, the switch matrix circuit 15SW includes six selector switches 150 to 155. The selector switches 150 to 155 are a 9-to-1 selector switch and is a 1-bit selector switch.

There are nine inputs in the switch matrix circuit 15SW. Specifically, there are inputs from three output ports provided in the I²S interfaces 108 of the two sound source cores 15C (total of six inputs: IN1 to IN6) and inputs from the outside (for example, the sound system 3) (total of three inputs: IN7 to IN9). Furthermore, the switch matrix circuit 15SW includes six systems as systems for distribution output. Specifically, there are outputs to three input ports included in the I²S interfaces 108 of the two sound source cores 15C (total of six distribution outputs: OUT1 to OUT6). Note that, in the switch matrix circuit 15SW, the input from the sound source core 15C is through-output to the outside. Therefore, the switch matrix circuit 15SW includes six 9-to-1 selector switches.

For example, in order to process the LR signal (digital musical sound data) of the sound source core 15CS in the sound source core 15CM, a case is considered in which two LR signals of the sound source core 15CS are input to the sound source core 15CM. In this case, for example, bit 4, that is, IN4 is selected in selector switch 150 to connect IN4 and OUT1. Similarly, when bit 5, that is, IN5 is selected in the selector switch 151, IN5 and OUT2 are connected. Therefore, the L signal and the R signal input from the sound source core 15CS to IN4 and IN5 are output from OUT1 and OUT2, respectively, and are input to the sound source core 15CM.

As another example, a case where an external input signal is input to the sound source core 15CS will be considered. In this case, for example, bit 7, that is, IN7 is selected in the selector switch 155 to connect IN7 and OUT6. Therefore, the external input signal input from the outside to IN7 is output from OUT6 and input to the sound source core 15CS.

With the configuration of the switch matrix circuit 15SW in this manner, various operation patterns of the switch matrix circuit 15SW can be set. For example, an operation pattern for transferring the I²S data from the sound source core 15CS to the sound source core 15CM can be set, and an operation pattern for transferring the I²S data from the sound source core 15CM to the sound source core 15CS can be set.

The same switch matrix circuit 15SW can be used in both a case where the switch matrix circuit is mounted on a product adopting the former operation pattern and a case where the switch matrix circuit is mounted on a product adopting the latter operation pattern. Since the same switch matrix circuit 15SW can be used in different products, for example, cost reduction is achieved.

A conventional sound source system has a configuration in which the effect processing and the like are performed on the digital musical sound data output from the plurality of sound source cores connected in parallel by a circuit at the subsequent stage of the sound source core. However, in such a configuration, for example, it is not possible to adopt a configuration in which a signal of one sound source core is input to the other sound source core and sound is further processed using a digital signal processor (DSP) resource of the other sound source core. Furthermore, in a case where the DSP resources of the plurality of sound source cores can be shared between the sound source cores, there is a possibility that the circuit scale of the sound source system increases.

Conventionally, for example, a case where the I²S data is transferred between two sound source cores 15C in a state where the phases of the BCK signal and the LRCK signal are not aligned between the two sound source cores 15C is considered. In this case, it is necessary to provide a switch matrix for all of the BCK signal, the LRCK signal, and the DATA signal in the I²S data. Therefore, each of the selector switches 150 to 155 needs to be configured by a 3-bit selector switch.

On the other hand, in the present embodiment, as described above, the phases of the BCK signal and the LRCK signal can be aligned between the two sound source cores 15C. Therefore, it is not necessary to provide a switch matrix for the BCK signal and the LRCK signal in the I²S data. Each of the selector switches 150 to 155 may be configured by a 1-bit selector switch for the DATA signal, so that the circuit scale of the switch matrix circuit 15SW can be suppressed to be small. In other words, since the signal whose connection is controlled by the switch matrix circuit 15SW does not include the signal of the clock (the BCK signal and the LRCK signal), the circuit scale of the switch matrix circuit 15SW is suppressed to be small.

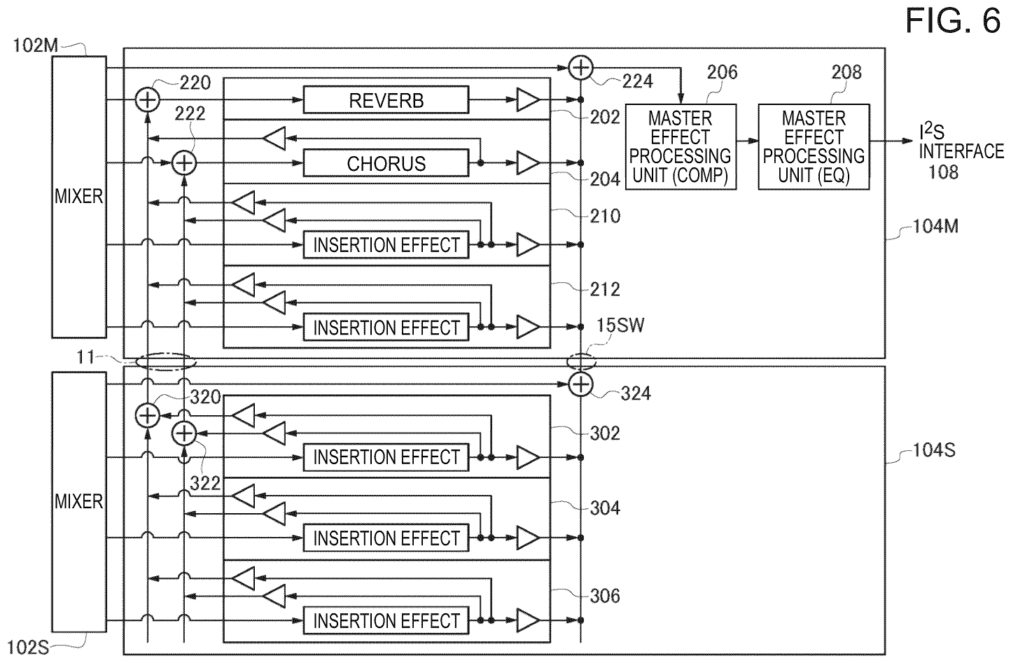

FIG. 6 is a diagram illustrating an example of effect processing by the DSP 104. In FIG. 6, among the mixers 102 and the DSPs 104 illustrated in FIG. 2, the mixer 102 and the DSP 104 included in the sound source core 15CM are referred to as a “mixer 102M” and a “DSP 104M”, respectively, and the mixer 102 and the DSP 104 included in the sound source core 15CS are referred to as a “mixer 102S” and a “DSP 104S”, respectively. Note that the DSP 104M includes system effect processing units 202 and 204 and master effect processing units 206 and 208 to be described later, whereas the DSP 104S does not include the system effect processing units 202 and 204 and the master effect processing units 206 and 208. However, since these processing units are set by software, the DSP 104M and the DSP 104S are the same in terms of hardware circuit structure.

As illustrated in FIG. 6, the DSP 104M includes system effect processing units 202 and 204, master effect processing units 206 and 208, insertion effect processing units 210 and 212, and adders 220, 222, and 224. The DSP 104S includes insertion effect processing units 302, 304, and 306 and adders 320, 322, and 324.

The system effect processing units 202 and 204 apply a system effect (for example, an effect such as a reverb which is generally connected to a send return terminal and is applied to the entire musical sound in terms of a background sound) shared by the sound source cores 15C. Therefore, the system effect processing units 202 and 204 are connected not only to the mixer 102M of the DSP 104M but also to the DSP 104S.

Here, in the insertion effect processing units 210, 212, 302, 304, and 306 and the system effect processing unit 204, the amplifier for the output signal to the left side (mixer 102M or 102S side) in FIG. 6 functions as a send volume of the signal to be input to the system effect processing units 202 and 204.

On the other hand, in the system effect processing units 202 and 204, the amplifiers for the output signals to the right side in FIG. 6 function as return volumes of the return signals from the system effect processing units 202 and 204, respectively. However, the chorus that is the system effect processing unit 204 in the present embodiment can also function as an insertion effect. In a case where the chorus of the system effect processing unit 204 is caused to function as an insertion effect, the send volume to the system effect processing unit 202 of the same processing unit may be set to “0”, and the send volume of each of the insertion effect processing units 210, 212, 302, 304, and 306 to the system effect processing unit 204 may be set to “0”.

The adder 220 arranged at the preceding stage of the system effect processing unit 202 adds the digital musical sound data (waveform data for reverb processing) output from the mixer 102M, the system effect processing unit 204, and the insertion effect processing units 210 and 212, and further adds the digital musical sound data (more specifically, the waveform data for the reverb processing output from the insertion effect processing units 302, 304, and 306 and added by the adder 320) output from the DSP 104S. The system effect processing unit 202 generates a reverb musical sound using the waveform data input from the adder 220 and outputs the waveform data of the generated reverb musical sound.

The adder 222 arranged at the preceding stage of the system effect processing unit 204 adds the digital musical sound data (waveform data for chorus processing) output from the mixer 102M, and the insertion effect processing units 210 and 212, and further adds the digital musical sound data (more specifically, the waveform data for the chorus processing output from the insertion effect processing units 302, 304, and 306 and added by the adder 322) output from the DSP 104S. The system effect processing unit 204 generates a chorus musical sound using the waveform data input from the adder 222 and outputs the waveform data of the generated chorus musical sound.

The master effect processing units 206 and 208 apply the master effect shared by the sound source cores 15C at the subsequent stages of the system effect processing units and the insertion effect processing units. Therefore, the master effect processing units 206 and 208 are connected to the system effect processing units, the insertion effect processing units, and the mixer 102M.

The adder 224 disposed at the preceding stage of the master effect processing unit 206 adds the waveform data output from the mixer 102M, the system effect processing units 202 and 204, and the insertion effect processing units 210 and 212, and further adds the waveform data (more specifically, the waveform data output from the mixer 102S and the insertion effect processing units 302, 304, and 306 and added by the adder 324) output from the DSP 104S.

The master effect processing unit 206 performs compressor processing on the digital musical sound data obtained by the addition by the adder 224. The master effect processing unit 208 performs equalizer processing on the digital musical sound data subjected to the compressor processing by the master effect processing unit 206. The digital musical sound data after the equalizer processing is output to the sound system 3 via the I²S interface 108.

The master effect processing units 206 and 208 play a role of adjusting the volume difference and adjusting the frequency characteristics in the final output stage of the musical sound so as to adjust the entire musical sound. Therefore, for a direct sound that does not pass through a system effect, it is desirable that the latency be minimized, and a signal in a state in which phases are aligned as much as possible among the plurality of sound source cores 15C be added by the adder 224 and input to the master effect processing unit 206.

The insertion effect processing units 210 and 212 apply an insertion effect only to the digital musical sound data input from the mixer 102M. That is, the insertion effect processing units 210 and 212 apply an effect that is not shared by the sound source cores 15C. For example, the insertion effect processing unit 210 and the insertion effect processing unit 212 apply mutually different insertion effects (for example, a flanger and a phaser).

The insertion effect processing units 302, 304, and 306 apply an insertion effect only to the digital musical sound data input from the mixer 102S. That is, the insertion effect processing units 302, 304, and 306 also apply mutually different effects that are not shared by the sound source cores 15C.

The output signals of the insertion effect processing units 210, 212, 302, 304, and 306 face the left side (mixer 102M or 102S side) in FIG. 6 and are divided into a signal passing through the system effect and a signal of direct sound that faces the right side in FIG. 6 and does not pass through the system effect. The direct sound desirably has a lower latency than a background sound that passes through a system effect such as a reverb or a chorus.

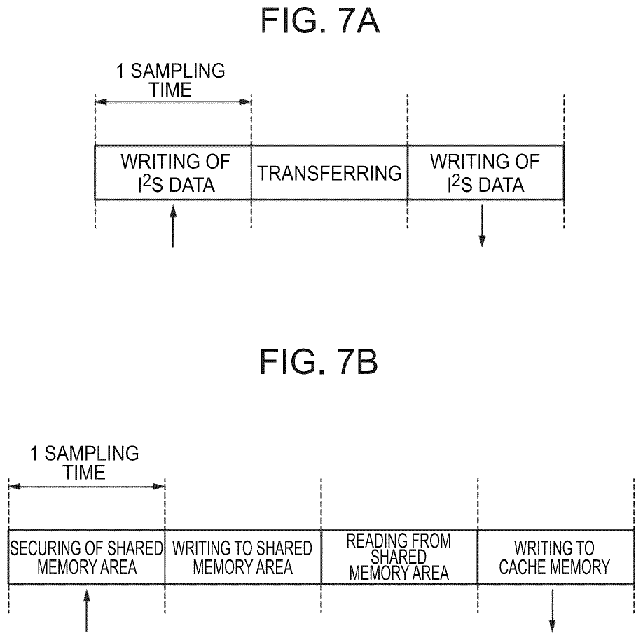

In the present embodiment, the digital musical sound data generated by the sound source core 15CS is transferred to the sound source core 15CM via the switch matrix circuit 15SW or via the shared memory. Here, FIG. 7A illustrates latency in a case where the digital musical sound data is transferred via the switch matrix circuit 15SW. Furthermore, FIG. 7B illustrates latency in a case where the digital musical sound data is transferred via the shared memory.

In the present embodiment, the RAM 11 (SRAM) having a small single access latency is used as a shared memory.

As illustrated in FIG. 7A, in a case where data passes via the switch matrix circuit 15SW, the I²S data is written to the register of the DSP 104S, the written I²S data is transferred, and the transferred I²S data is written to the register of the DSP 104M. Therefore, the digital musical sound data generated by the sound source core 15CS is delayed by about 2 samplings with respect to the digital musical sound data generated by the sound source core 15CM.

As illustrated in FIG. 7B, in a case where data passes via the shared memory, the shared memory area is secured, the digital musical sound data is written in the secured shared memory area, the written digital musical sound data is read from the shared memory area, and the read digital musical sound data is written in the cache memory of the DSP 104M. Therefore, the digital musical sound data generated by the sound source core 15CS is delayed by about 3 samplings with respect to the digital musical sound data generated by the sound source core 15CM.

Note that there is a sufficient possibility that the write latency and the read latency in the shared memory become larger depending on the operation status of the RAM 11. Therefore, the digital musical sound data generated by the sound source core 15CS may be delayed more greatly than the digital musical sound data generated by the sound source core 15CM.

That is, in a case where the digital musical sound data is transferred via the switch matrix circuit 15SW, the latency can be suppressed to be small as compared with a case where the digital musical sound data is transferred via the shared memory.

As described above, the direct sound from each insertion effect is desirably lower in latency than the sound passing through the system effect. Therefore, under the control of the CPU 10, the digital musical sound data output from the insertion effect processing units 302, 304, and 306 of the mixer 102S and the DSP 104S, that is, the waveform data after addition by the adder 324 is transferred from the sound source core 15CS to the master effect processing unit 206 via a path with low latency, that is, via the switch matrix circuit 15SW.

However, the number of input/output paths is limited in paths via the switch matrix circuit 15SW. In a case where the number of input/output paths is increased, the number of input/output of the switch matrix circuit 15SW is increased, and the circuit scale of the switch matrix circuit 15SW is increased.

On the other hand, if a ring buffer is formed on the RAM 11 via the shared memory, the number of paths that can be transferred is almost unlimited. Furthermore, by increasing the size of the ring buffer, the amount of transfer data per one path can be increased. However, in this case, the latency until the written data is read increases. Furthermore, as described above, the reverb processing and the chorus processing by the system effect processing units 202 and 204 may have somewhat higher latency than the insertion effect processing.

Therefore, in the present embodiment, under the control of the CPU 10, the digital musical sound data output from the insertion effect processing units 302, 304, and 306 of the DSP 104S, that is, the waveform data after addition by the adder 320 is transferred from the sound source core 15CS to the system effect processing unit 202 via the shared memory. Furthermore, under the control of the CPU 10, the digital musical sound data output from the insertion effect processing units 302, 304, and 306 of the DSP 104S, that is, the waveform data after addition by the adder 322 is transferred from the sound source core 15CS to the system effect processing unit 204 via the shared memory.

As described above, in the present embodiment, by using the switch matrix circuit 15SW and the shared memory in combination, it is possible to transfer a large amount of data during one sampling while suppressing the circuit scale of the switch matrix circuit 15SW to be small.

Note that the processing example illustrated in FIG. 6 is merely an example. A configuration in which the reverb, the chorus, the compressor, and the equalizer are not shared and a configuration in which the non-shared insertion effect is shared in the present embodiment are also within the scope of the present disclosure. Furthermore, a configuration for performing another effect processing not illustrated in FIG. 6 is also within the scope of the present disclosure.

As described above, the CPU 10 executes the program stored in the ROM 12 to operate as a connection control unit that controls the connection among the plurality of sound source cores 15C such that the digital musical sound data in which the phases of the clocks (the BCK signal and the LRCK signal) are aligned is transferred among the plurality of sound source cores 15C. More specifically, the CPU 10 operating as a connection control unit controls the connection among the plurality of sound source cores 15C via the switch matrix circuit 15SW.

Furthermore, one sound source core 15CM in the plurality of sound source cores 15C performs the first effect processing and the second effect processing on the first musical sound data and the second musical sound data from each of the plurality of sound source cores 15C. The first musical sound data is digital musical sound data to which the first effect processing (for example, insertion effect processing) in which an allowable value for latency at the time of transfer is smaller than that of the second effect processing (for example, reverb processing and chorus processing) is applied, and is transferred in the I²S format among the plurality of sound source cores 15C. The second musical sound data is digital musical sound data to which the second effect processing having a larger allowable value for latency at the time of transfer than that of the first effect processing is applied, and is transferred among the plurality of sound source cores 15C via the shared memory. In addition, it can be said that the first effect processing is processing requiring a lower latency at the time of transferring musical sound data than the second effect processing.

As described above, in the present embodiment, since the phases of the BCK signal and the LRCK signal are aligned among the plurality of sound source cores 15C, each of the selector switches 150 to 155 can be configured with the 1-bit selector switch even in the configuration in which the effect is shared among the plurality of sound source cores 15C, and the circuit scale of the switch matrix circuit 15SW can be suppressed to be small.

In addition, the present invention is not limited to the above-described embodiments, and various modifications can be made in the implementation stage without departing from the gist thereof. Furthermore, the functions executed in the above-described embodiments may be appropriately combined and implemented as much as possible. The above-described embodiments include various stages, and various inventions can be extracted by appropriate combinations of a plurality of disclosed constituent elements. For example, even if some components are deleted from all the components shown in the embodiment, if an effect can be obtained, a configuration from which the components are deleted can be extracted as an invention.

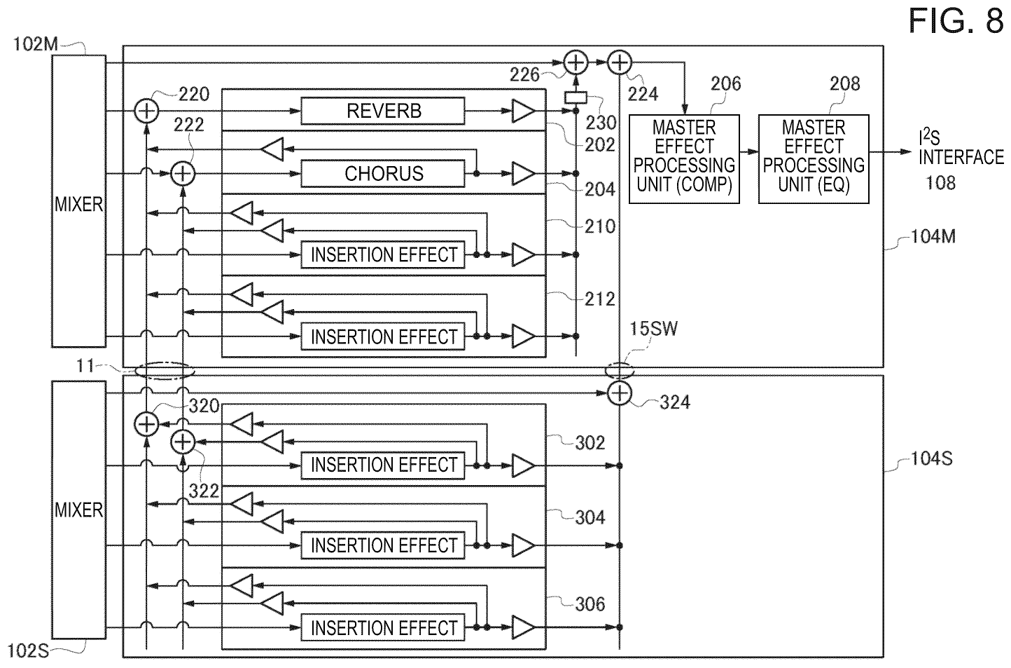

FIG. 8 is a diagram illustrating an example of effect processing by the DSP 104 according to a first modification of the present invention.

As described above, the digital musical sound data generated by the sound source core 15CS has latency at the time of transfer, and thus is delayed with respect to the digital musical sound data generated by the sound source core 15CM. Therefore, in the first modification, a delay circuit 230 is arranged at a stage subsequent to the system effect processing units 202 and 204 and the insertion effect processing units 210 and 212. The delay circuit 230 delays the input waveform data by, for example, 2 samplings.

The waveform data delayed by the delay circuit 230 and the waveform data from the mixer 102M are added by the adder 226, and the added data is further added to the waveform data transferred from the sound source core 15CS via the switch matrix circuit 15SW by the adder 224 so as to be input to the master effect processing unit 206.

That is, in the first modification, the master effect processing unit 206 receives digital musical sound data in which a phase difference between the digital musical sound data generated by the sound source core 15CS (waveform data passing via the switch matrix circuit 15SW) and the digital musical sound data generated by the sound source core 15CM (waveform data not passing via the switch matrix circuit 15SW) is suppressed.

As described above, the sound source core 15CM includes the delay circuit 230 (an example of the phase difference suppression unit) that suppresses the phase difference of the musical sound data from each of the plurality of sound source cores 15C.

The method of performing the synchronization control of the operation counters 112 among the plurality of sound source cores 15C is not limited to the method using the reset pulse.

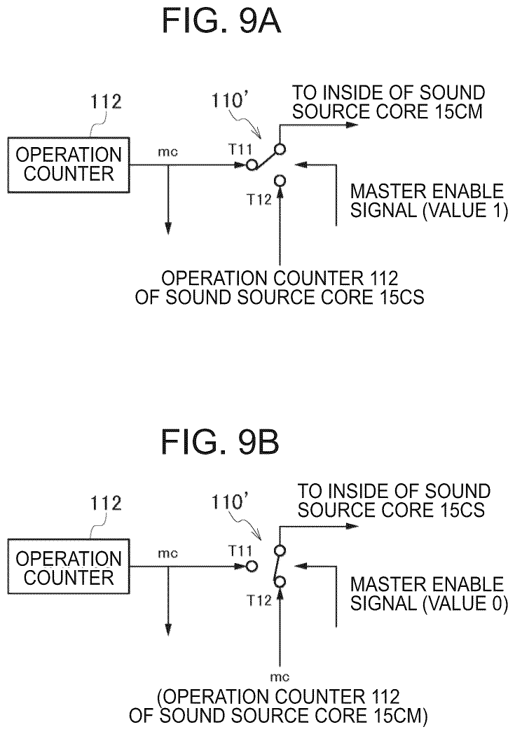

FIGS. 9A and 9B are diagrams corresponding to the sound source core 15CM and the sound source core 15CS, respectively, and are block diagrams illustrating configurations of a switch 110′ and the operation counter 112 according to a second modification of the present invention. The sound source system 1 according to the second modification includes the configurations illustrated in FIGS. 9A and 9B instead of the configuration illustrated in FIG. 3.

The CPU 10 outputs a master enable signal having a value of 1 to the sound source core 15CM set as a master, and outputs a master enable signal having a value of 0 to the sound source core 15CS set as a slave. The master enable signal is a control signal for the switch 110′.

As illustrated in FIG. 9A, in the sound source core 15CM, the switch 110′ is connected to a contact T11 according to the master enable signal. Therefore, the operation counter 112 of the sound source core 15CM and the inside of the sound source core 15CM (supply destination of the value mc) are connected, and the connection between the operation counter 112 of the sound source core 15CS and the inside of the sound source core 15CM is cut off.

Furthermore, as illustrated in FIG. 9B, in the sound source core 15CS, the switch 110′ is connected to a contact T12 according to the master enable signal. Therefore, the connection between the operation counter 112 of the sound source core 15CS and the inside of the sound source core 15CS (supply destination of the value mc) is cut off, and the operation counter 112 of the sound source core 15CM and the inside of the sound source core 15CS are connected.

Therefore, the value mc generated by the operation counter 112 of the sound source core 15CM is supplied to the inside of the sound source core 15CM and to the inside of the sound source core 15CS. Since the common value mc is supplied to the two sound source cores 15C, the phases of the BCK signal and the LRCK signal generated based on the value mc are aligned between the two sound source cores 15C.

Depending on the sound production state of the musical sound (for example, a case where the number of musical sounds to be produced is small), it is not necessary to operate at least one sound source core 15C. Therefore, in order to reduce the current consumption of the sound source system 1, the supply of the basic operation clock to at least one sound source core 15C may be stopped according to the sound production state of the musical sound (in other words, depending on the processing situation of the musical sound data).

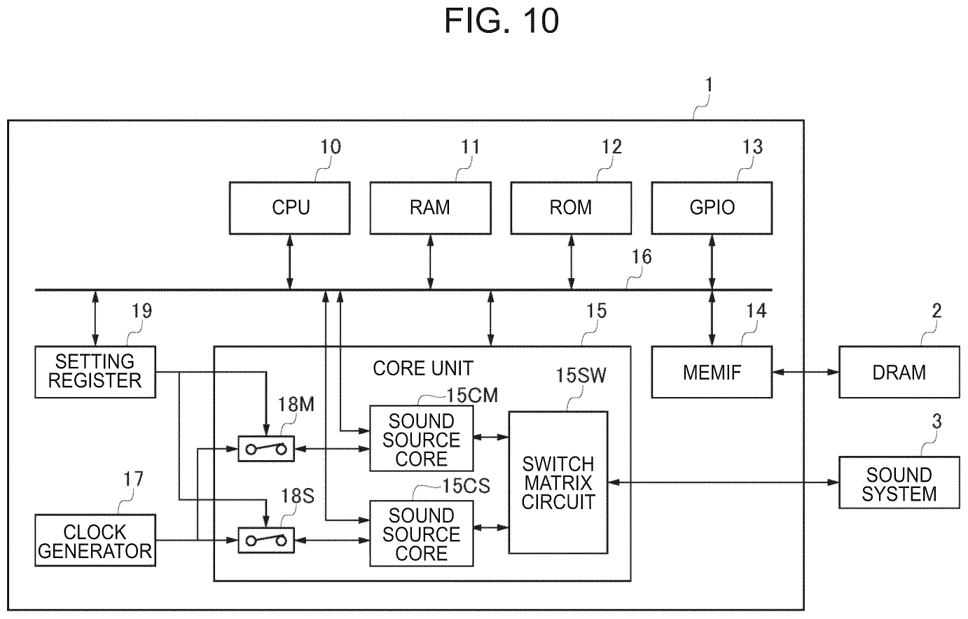

FIG. 10 is a block diagram illustrating a configuration of a sound source system 1 according to a third modification of the present invention. FIG. 10 illustrates a clock generator 17 that supplies the basic operation clock to each unit of the sound source system 1. The clock generator 17 is an example of a basic operation clock supply unit that supplies a basic operation clock for operating the plurality of sound source cores 15C.

As illustrated in FIG. 10, in the third modification, a clock gating switch 18M is disposed between the clock generator 17 and the sound source core 15CM. Furthermore, a clock gating switch 18S is disposed between the clock generator 17 and the sound source core 15CS.

The CPU 10 writes a value in a setting register 19 according to the sound production state of the musical sound. For example, when the value 1 is written for the sound source core 15CM, an enable signal of the value 1 is output from the setting register 19 to the clock gating switch 18M. Therefore, the clock gating switch 18M connects the clock generator 17 and the sound source core 15CM, and the basic operation clock is supplied from the clock generator 17 to the sound source core 15CM. When the value 0 is written for the sound source core 15CM, an enable signal of the value 0 is output from the setting register 19 to the clock gating switch 18M. Therefore, the clock gating switch 18M cuts off the connection between the clock generator 17 and the sound source core 15CM, and the supply of the basic operation clock from the clock generator 17 to the sound source core 15CM is stopped. Therefore, the sound source core 15CM stops.

With respect to the sound source core 15CS, connection and interruption of the connection between the clock generator 17 and the sound source core 15CS are performed by the clock gating switch 18S in a similar operation. During the connection between the clock generator 17 and the sound source core 15CS, the basic operation clock is supplied from the clock generator 17 to the sound source core 15CS. During the interruption of the connection between the clock generator 17 and the sound source core 15CS, the supply of the basic operation clock from the clock generator 17 to the sound source core 15CS is stopped, so that the sound source core 15CS is stopped.

As described above, the CPU 10 executes the program stored in the ROM 12 to operate as a supply control unit that controls the supply and stop of the supply of the basic operation clock to each of the plurality of sound source cores 15C by the clock generator 17 (an example of the basic operation clock supply unit) according to the processing situation of the digital musical sound data.

In a case where the third modification is applied to the second modification, first, in the configuration illustrated in FIGS. 9A and 9B, the sound source core 15CM supplies the value mc to the sound source core 15CS. When only the sound source core 15CM is stopped, since the value mc is not supplied to the sound source core 15CS, a problem occurs in the operation of the sound source core 15CS. Therefore, in a case where there is only one sound source core 15C that can be stopped, only the sound source core 15CS is stopped. Only when the number of stoppable sound source cores 15C becomes 2, the sound source core 15CM is also stopped.

In the configuration illustrated in FIGS. 9A and 9B, even if only the operation of the sound source core 15CS is restarted from the state in which the two sound source cores 15C are stopped, the value mc is not supplied to the sound source core 15CS. Therefore, a problem occurs in the operation of the sound source core 15CS. Therefore, first, only the operation of the sound source core 15CM is restarted, and then the operation of the sound source core 15CS is also restarted as necessary.

In the configuration illustrated in FIGS. 9A and 9B, when the operation of the sound source core 15CS is restarted, the value mc generated by the operation counter 112 of the sound source core 15CM is also supplied to the inside of the sound source core 15CS. Therefore, the phases of the BCK signal and the LRCK signal are aligned between the two sound source cores 15C even after the operation is restarted.

In the configuration illustrated in FIG. 3, a reset pulse is supplied to each sound source core 15C when the operation of the sound source core 15CS is restarted. Therefore, also in this case, the phases of the BCK signal and the LRCK signal are aligned between the two sound source cores 15C even after the operation is restarted.

Although the embodiments of the present disclosure have been described above, the technical scope of the present disclosure is not limited to the above-described embodiments as it is, and various modifications can be made without departing from the gist of the present disclosure. Furthermore, components of different embodiments and modifications may be appropriately combined. Furthermore, the effects of each embodiment described in the present specification are merely examples and are not limited, and other effects may be provided.

What is claimed is:

1. A sound source system comprising:
a plurality of sound source cores that process musical sound data;
a phase control circuit that aligns phases of clocks defining an input/output timing of the musical sound data with respect to a sound source core among the plurality of sound source cores; and
a connection control circuit that controls connection among the plurality of sound source cores such that musical sound data in which phases of the clocks are aligned is transferred among the plurality of sound source cores.

2. The sound source system according to claim 1, further comprising: a switch matrix circuit that is connectable to each of the plurality of sound source cores, wherein
the connection control circuit controls connection among the plurality of sound source cores via the switch matrix circuit.

3. The sound source system according to claim 2, wherein
a signal whose connection is controlled by the switch matrix circuit does not include a signal of the clock.

4. The sound source system according to claim 1, wherein
first musical sound data is transferred, among the plurality of sound source cores, in an inter-IC sound interface (I²S) format.

5. The sound source system according to claim 1, further comprising: a shared memory that is shared among the plurality of sound source cores, wherein
second musical sound data is transferred, among the plurality of sound source cores, via the shared memory.

6. The sound source system according to claim 5, wherein
one sound source core in the plurality of sound source cores performs first effect processing and second effect processing on the first musical sound data and the second musical sound data from each of the plurality of sound source cores, and
the first effect processing is processing requiring a lower latency at a time of transferring the musical sound data than the second effect processing.

7. The sound source system according to claim 6, wherein
the one sound source core includes a phase difference suppression circuit that suppresses a phase difference of the musical sound data from each of the plurality of sound source cores.

8. The sound source system according to claim 1, wherein
the phase control circuit supplies an instruction signal to each of the plurality of sound source cores, and
when the instruction signal is supplied to each of the plurality of sound source cores, values of operation counters of the sound source cores are synchronized among the plurality of sound source cores, and each of the plurality of sound source cores generates the clock on a basis of a value of the operation counter in a synchronized state.

9. The sound source system according to claim 8, wherein
each of the plurality of sound source cores includes:
a control signal output circuit that outputs a control signal according to the instruction signal; and
a value generation circuit that generates a value based on the control signal.

10. The sound source system according to claim 9, wherein
the control signal output circuit includes:
a setting circuit that modulates a setting value according to the instruction signal;
an edge detection circuit that detects a rising edge of a signal according to modulation of a setting value in the setting circuit and generates a reset signal according to an edge; and
a control signal output circuit that outputs an output signal according to an input of a reset signal from the edge detection circuit and an input of a reset signal from an edge detection circuit of another sound source core among the plurality of sound source cores.

11. The sound source system according to claim 10, wherein
the value generation circuit generates the value on a basis of the output signal.

12. The sound source system according to claim 1, further comprising:
a basic operation clock supply circuit that supplies a basic operation clock for operating the plurality of sound source cores; and
a supply control circuit that controls supply and stop of the supply of the basic operation clock to each of the plurality of sound source cores by the basic operation clock supply circuit according to a processing situation of the musical sound data.

13. The sound source system according to claim 1, wherein
the plurality of sound source cores have a same circuit structure.

14. A method of controlling a sound source system including a plurality of sound source cores that process musical sound data, the method causing the sound source system to execute:
aligning phases of clocks that define input/output timings of the musical sound data with respect to the sound source core among the plurality of sound source cores; and
controlling connection among the plurality of sound source cores such that musical sound data in which phases of the clocks are aligned is transferred among the plurality of sound source cores.

15. A non-transitory recording medium for controlling a sound source system including a plurality of sound source cores that process musical sound data, the program causing the sound source system to execute:
aligning phases of clocks that define input/output timings of the musical sound data with respect to the sound source core among the plurality of sound source cores; and
controlling connection among the plurality of sound source cores such that musical sound data in which phases of the clocks are aligned is transferred among the plurality of sound source cores.
